(19) United States
(12) Patent Application Publication
(10) Pub. No.: US 2022/0198088 A1
(43) Pub. Date: Jun. 23, 2022

(54) System and Method for Automated and Integrated Plant Design

(71) Applicant: Parla Sanaye Company, Tehran (IR)

(72) Inventors: Alireza Sargheiny, Tehran (IR); Amir Sargheiny, Tehran (IR); Navid Sargheiny, Tehran (IR); Farshid Sargheiny, Tehran (IR)

(21) Appl. No.: 17/695,054

(22) Filed: Mar. 15, 2022

(51) Int. Cl. G06F 30/13; G06F 30/18; G06F 30/12; G06F 30/27

(52) U.S. Cl. CPC G06F 30/13; G06F 30/27; G06F 30/12; G06F 30/18

(57) ABSTRACT

An automated and integrated plant design system and method are developed to perform an optimized design of various aspects of a plant structure. The method includes providing a plant library, designing P&ID, PFD, plant civil model, plant piping model, plant electrical system, plant HVAC model, and plant equipment model utilizing a computing device and generating an 3D integrated plant model. A computer program is designed to implement the plant design method. The system comprises a computing device and a computer program that comprises a plurality of graphical user interfaces (GUIs) and an artificial intelligence (AI) engine. The graphical user interfaces comprise a plurality of dynamic templates that enable users to perform a plant design process.

### TECHNICAL FIELD

The present disclosure is related generally to engineering design and, more specifically, to systems and methods for the automated and integrated designing of various aspects of a plant structure.

### BACKGROUND

The design and construction of a new or retrofit process (power, chemical, refinery, or other) plant are incredibly complex and expensive, involving designers, engineers, and construction teams from many different companies and disciplines, all attempting to perform their work in parallel to get a plant built and up-and-running in the shortest time possible.

Also, the plant construction comprises a variety of units including civil structure, electrical structure, piping structure, heating, ventilation, and air conditioning (HVAC) structure, and so on. Designing each of the above-mentioned structures takes a lot of time and needs experts in those fields. Furthermore, the plant and sub-plant design process can be a time-consuming, cumbersome, and error-prone process.

Thus, to overcome the above-mentioned issues, an automated system and method have been introduced to perform an automated and optimized designing of plant and sub-plant units. Also, a computer program has been developed to perform integrated plant design, utilizing a computing device through a plurality of graphical user interface (GUI) modules.

### SUMMARY

This summary is intended to provide an overview of the subject matter of this disclosure, and is not intended to identify essential elements or key elements of the subject matter, nor is it intended to be used to determine the scope of the claimed implementations. The proper scope of this disclosure may be ascertained from the claims set forth below in view of the detailed description below and the drawings.

In one general aspect, the present disclosure describes an exemplary method for integrated plant designing. An exemplary method may include providing a plant library based on one or more user's selections utilizing a computing device such that the plant library may include a pre-defined database, a user-defined database, or the pre-defined and user-defined databases. The exemplary method may further include designing a process flow diagram (PFD) and a piping & instrumentation diagram (P&ID) by a user based on a plurality of P&ID components such that the user may select each of the plurality of P&ID components and may modify and manage each of the plurality of P&ID components associated with the P&ID and PFD, designing a plant civil structure model by the user based on a plurality of civil components such that the plant civil structure may be associated with a plurality of steel and concrete structures and the user may select one or more civil components and may modify and manage each of the plurality of civil components associated with the plant civil structure to perform designing and modeling one or more steel and concrete structures, and designing a plant equipment model by the user based on a plurality of plant equipment such that the user may select each of the plurality of plant's equipment and may modify and design each of the plurality of plant's equipment in two dimensions and three dimensions models. Furthermore, The method may include designing a plant piping structure model by the user based on a plurality of piping components such that the user may select each of the plurality of piping components and may perform designing and modeling of the plant piping structure, designing a plant electrical model by the user based on a plurality of electrical components such that the user may select each of the plurality of electrical components and may modify and design each of the plurality of electrical components, designing a plant heating, ventilation, and air conditioning (HVAC) model by the user based on a plurality of HVAC components such that the user may select each of the plurality of HVAC components and may modify and design the plant HVAC model, which designing the PFD and P&ID, the plant civil structure model, the plant equipment model, the plant piping structure model, the plant electrical model, and the plant HVAC model may be provided through the plant library utilizing a computing device. The method may further include combining each of the PFD and P&ID, the plant civil structure model, the plant piping structure model, the plant electrical model, and the plant HVAC model by the user and generating an integrated 3-dimensional (3D) model of a plant design utilizing a computing device.

The above general aspect may have one or more of the following features. In an exemplary implementation, the user may generate an optimized design utilizing a computing device through a set of user's input specifications and the plant library. In an exemplary implementation, the computing device may comprise a processing unit, a storage unit, a display unit, and an input/output (I/O) unit. In an exemplary implementation, the pre-defined database may comprise one or more P&ID components, one or more civil components, one or more plant equipment, one or more piping components, one or more electrical components, and one or more HVAC components.

In another general aspect, the present disclosure is directed to an exemplary system that enables users to perform an integrated plant design utilizing artificial intelligence (AI). The exemplary system may comprise a computing device that may comprise a display unit, a storage unit having processor-readable instructions and an application stored therein, a processing unit that may comprise one or more processors such that the processing unit may be configured to access the storage unit and execute the processor-readable instructions and the application which, when executed by the one or more processors configures the one or more processors to perform a method that is associated with the application, and an input/output (I/O) unit such that the I/O unit may include a plurality of peripheral devices. The exemplary system may further comprise the application executing on the computing device that may comprise one or more graphical user interface (GUI) modules, an application core, an application engine, and an application database. Furthermore, an integrated plant design process utilizing the application may comprise defining one or more users utilizing an admin module such that the users may comprise an admin user and one or more ordinary users, wherein the admin user may assign ordinary users' roles and manage the ordinary users, providing a plant library based on the ordinary users' roles utilizing a data module such that the plant library may comprise a pre-defined database, a user-defined database, or the pre-defined and user-defined databases, designing a process flow diagram (PFD) and a piping & instrumentation diagram (P&ID) by a P&ID user based on a plurality of P&ID components utilizing a P&ID module such that the P&ID user may select each of the plurality of P&ID components and may modify and manage each of the plurality of P&ID components associated with the P&ID and PFD, designing a plant civil structure model by a civil user based on a plurality of civil components utilizing a civil module such that the plant civil structure may be associated with a plurality of steel and concrete structures and the civil user may select one or more civil components and may modify and manage each of the plurality of civil components associated with the plant civil structure to perform designing and modeling one or more steel and concrete structures, designing a plant equipment model by an equipment user based on a plurality of plant equipment utilizing an equipment module such that the equipment user may select each of the plurality of plant's equipment and may modify and design each of the plurality of plant's equipment in two dimensions and three dimensions model, designing a plant piping structure model by a piping user based on a plurality of piping components utilizing a piping module such that the piping user selects each of the plurality of piping components and may perform designing and modeling of the plant piping structure, designing a plant electrical model by an electrical user based on a plurality of electrical components utilizing an electrical module such that the electrical user may select each of the plurality of electrical components and may modify and design each of the plurality of electrical components, designing a plant heating, ventilation, and air conditioning (HVAC) model by an HVAC user based on a plurality of HVAC components utilizing an HVAC module such that the HVAC user may select each of the plurality of HVAC components and may modify and design the plant HVAC model, such that designing the PFD and P&ID, the plant civil structure model, the plant equipment model, the plant piping structure model, the plant electrical model, and the plant HVAC model may be provided through the plant library and artificial intelligence (AI) algorithms, and combining each of the PFD and P&ID, the plant civil structure model, the plant piping structure model, the plant electrical model, and the plant HVAC model, and generating an integrated 3-dimensional (3D) model of a plant design utilizing the application engine.

The above general aspect may have one or more of the following features. In an exemplary implementation, the application engine may comprise an AI engine such that the AI engine may be configured to perform an automatic and optimized design through the application database and a set of users' input specifications. In an exemplary implementation, the application core may be configured to establish a connection between the GUI modules, the application engine, the application database, and the computing device. In an exemplary implementation, the application database may comprise a pre-defined database and a user-defined database. In an exemplary implementation, the pre-defined database may comprise a P&ID database, a civil database, an equipment database, an electrical database, a piping database, and an HVAC database. In an exemplary implementation, wherein the P&ID components, the civil components, the plant equipment, the piping components, the electrical components, and the HVAC components may be provided as dynamic templates in the application. In an exemplary implementation, dynamic templates comprise one or more component figures and a set of component specifications. In an exemplary implementation, the set of component specifications may comprise one or more numerical constraints and/or constants, one or more component dimensions, type of component, component material, and a plurality of design variables that may be determined by the users. In an exemplary implementation, the storage unit comprises one or more memories that may be associated with the application and the processing unit. In an exemplary implementation, the application comprises an automated design mode, a semi-automated design mode, and a manual design mode for each of the GUI modules.

### BRIEF DESCRIPTION OF THE DRAWINGS

The drawing figures depict one or more implementations in accordance with the present teachings, by way of example only, not by way of limitation. In the figures, like reference numerals refer to the same or similar elements.

FIG. 1 illustrates a flowchart of a method for integrated plant designing, consistent with one or more exemplary embodiments of the present disclosure.

FIG. 2 shows a high-level functional block diagram of a computer system, consistent with one or more exemplary embodiments of the present disclosure.

FIG. 3 illustrates a structural block diagram of a computer program, consistent with one or more exemplary embodiments of the present disclosure.

FIG. 4 illustrates an example of a plant admin module of a plant design application, consistent with one or more exemplary embodiments of the present disclosure.

FIG. 5 illustrates an example of a plant data module of a plant design application, consistent with one or more exemplary embodiments of the present disclosure.

FIG. 6 illustrates an example of a plant P&ID module of a plant design application, consistent with one or more exemplary embodiments of the present disclosure.

FIG. 7 illustrates an example of a plant civil module of a plant design application, consistent with one or more exemplary embodiments of the present disclosure.

FIG. 8 illustrates an example of a plant equipment module of a plant design application, consistent with one or more exemplary embodiments of the present disclosure.

FIG. 9 illustrates an example of a plant piping module of a plant design application, consistent with one or more exemplary embodiments of the present disclosure.

FIG. 10 illustrates an example of a plant electrical module of a plant design application, consistent with one or more exemplary embodiments of the present disclosure.

FIG. 11 illustrates an example of a plant HVAC module of a plant design application, consistent with one or more exemplary embodiments of the present disclosure.

FIG. 12 illustrates an example of a plant viewer module of a plant design application, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings_may be practiced without such details. In other instances, well-known methods, components, and/or elements have been described at a relatively high-level, without detail, in order to avoid unnecessarily obscuring aspects of the present teachings. The following detailed description is, therefore, not to be taken in a limiting sense, and the scope of the present disclosure is defined only by the appended claims.

The following detailed description is presented to enable a person skilled in the art to make and use the methods and apparatuses disclosed in exemplary embodiments of the present disclosure. For purposes of explanation, specific nomenclature is set forth provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

In an exemplary embodiment, an exemplary integrated plant design system and method may be developed to perform an automatic and optimized design of various aspects of a plant structure. In an exemplary embodiment, various aspects of a plant structure may include a piping structure, an electrical structure, a civil structure, a heating, ventilation, and air conditioning (HVAC) structure, and other aspects of a plant structure that are well known for those skilled in the art. In an exemplary embodiment, a plant may be referred to a building or facility that is industrial, such as a factory, oil, gas, petrochemical, and power plants.

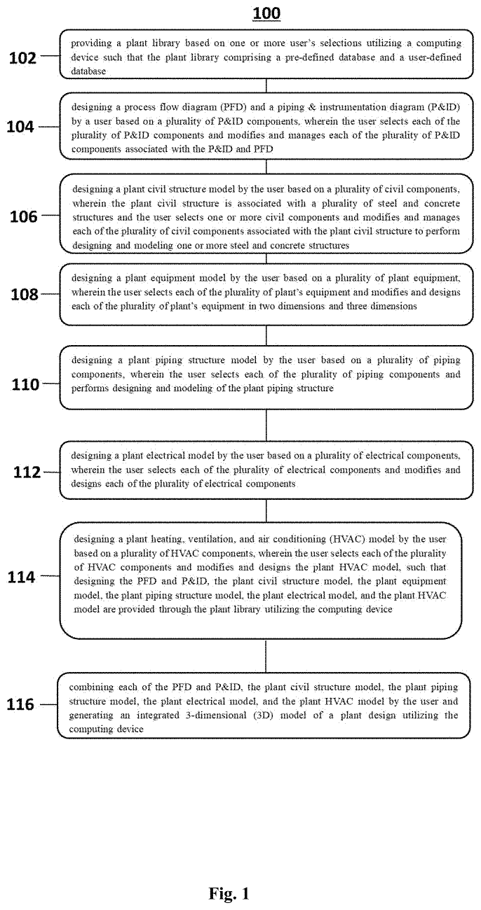

FIG. 1 illustrates a flowchart of an exemplary method for integrated plant designing. In an exemplary embodiment, as illustrated in FIG. 1, method 100 may comprise a plurality of steps that may be configured to perform an integrated design of various aspects of a plant structure.

In an exemplary embodiment, step 102 may comprise providing a plant library based on one or more user's selections utilizing a computing device such that the plant library may comprise a pre-defined database, a user-defined database, or the pre-defined and user-defined databases. In an exemplary embodiment, step 104 may comprise designing a process flow diagram (PFD) and a piping & instrumentation diagram (P&ID) by a user based on a plurality of P&ID components such that the user may select each of the plurality of P&ID components and may modify and manage each of the plurality of P&ID components associated with the P&ID and PFD. In an exemplary embodiment, step 106 may comprise designing a plant civil structure model by the user based on a plurality of civil components, wherein the plant civil structure may be associated with a plurality of steel and concrete structures and the user may select one or more civil components and may modify and manage each of the plurality of civil components associated with the plant civil structure to perform designing and modeling one or more steel and concrete structures. In an exemplary embodiment, step 108 may comprise designing a plant equipment model by the user based on a plurality of plant equipment, wherein the user may select each of the plurality of plant's equipment and may modify and design each of the plurality of plant equipment in two dimensions and three dimensions models. In an exemplary embodiment, step 110 may comprise designing a plant piping structure model by the user based on a plurality of piping components, wherein the user may select each of the plurality of piping components and may perform designing and modeling of the plant piping structure. In an exemplary embodiment, step 112 may comprise designing a plant electrical model by the user based on a plurality of electrical components, wherein a user may select each of the plurality of electrical components and may modify and design each of the plurality of electrical components. In an exemplary embodiment, step 114 may comprise designing a plant heating, ventilation, and air conditioning (HVAC) model by the user based on a plurality of HVAC components, wherein the user may select each of the plurality of HVAC components and may modify and design the plant HVAC model. In an exemplary embodiment, designing the PFD and P&ID, the plant civil structure model, the plant equipment model, the plant piping structure model, the plant electrical model, and the plant HVAC model may be provided through the plant library utilizing a computing device. In an exemplary embodiment, step 116 may comprise combining each of the PFD and P&ID, the plant civil structure model, the plant piping structure model, the plant electrical model, and the plant HVAC model by the user and generating an integrated 3-dimensional (3D) model of a plant design utilizing a computing device.

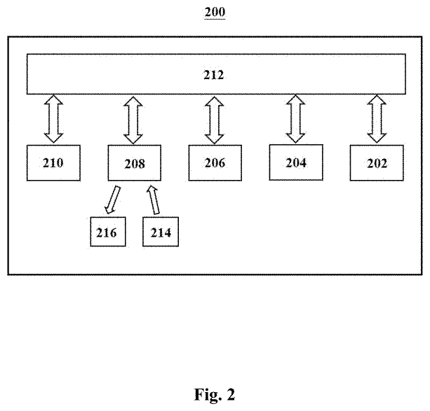

FIG. 2 shows an example computer system 200 in which an embodiment of the present invention, or portions thereof, may be implemented as computer-readable code, consistent with exemplary embodiments of the present disclosure. For example, method 100 may be implemented as an application in computer system 200 using hardware, software, firmware, tangible computer-readable media having instructions stored thereon, or a combination thereof and may be implemented in one or more computer systems or other processing systems.

If programmable logic is used, such logic may execute on a commercially available processing platform or a special purpose device. One ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device

For instance, a computing device having at least one processor device and a memory may be used to implement the above-described embodiments. A processor device may be a single processor, a plurality of processors, or combinations thereof. Processor devices may have one or more processor “cores.”

In an exemplary embodiment, computer system 200 may comprise a processing unit 202, a storage unit 204, a display unit 206, an I/O interface 208, a network interface 210, a communication infrastructure 212, an input device unit 214, and an output device unit 216.

In an exemplary embodiment, processing unit 202 may comprise one or more processor devices. In an exemplary embodiment, a processor device may be an application-specific processor device or a general-purpose processor device. In an exemplary embodiment, a processor device may comprise a microcontroller, a microprocessor, an embedded processor, a DSP processor, a media processor, or other types of processor devices that are well known for those skilled in the art. In an exemplary embodiment, processing unit 202 may be connected to communication infrastructure 212. In an exemplary embodiment, the communication infrastructure 212 may comprise a bus, message queue, network, multi-core message-passing scheme, or other types of communication infrastructures that are well known for those skilled in the art. In an exemplary embodiment, processing unit 202 may manage and communicate with storage unit 204, display unit 206, I/O interface 208, network interface 210, input device unit 214, and output device unit 216 through communication infrastructure 212.

In an exemplary embodiment, storage unit 204 may comprise a primary storage device and a secondary storage device. In an exemplary embodiment, a primary storage device may comprise random-access memory (RAM), read-only memory (ROM), cache, flash memory, video memory, register, or other types of primary storage devices that are well known for those skilled in the art. In an exemplary embodiment, a secondary storage device may include a hard disk drive, solid-state drive, removable “USB” drive, CD, DVD, or other types of secondary storage devices that are well known for those skilled in the art. As will be appreciated by persons skilled in the relevant art, storage unit 204 may include computer software and/or data, for example operating system (OS), having stored therein. In an exemplary embodiment, storage unit 204 may be connected to communication infrastructure 212.

In an exemplary embodiment, display unit 206 may comprise a display interface and a display device. In an exemplary embodiment, a display interface, for example, a connector, may be configured to transmit data, for example, video and audio, to a display device. In an exemplary embodiment, a display device may comprise a monitor, projector, or other types of display devices that are well known for those skilled in the art. In an exemplary embodiment, display unit 206 may be connected to communication infrastructure 212.

In an exemplary embodiment, network interface 210 may be configured to connect computer system 200 to a computer network and may allow computer software and data to be transferred between computer system 200 and external devices. In an exemplary embodiment, network interface 210 may comprise a wireless interface, a wired interface, a USB interface, fiber optic interface, or other types of network interfaces that are well known for those skilled in the art. In an exemplary embodiment, network interface 210 may be connected to communication infrastructure 212.

In an exemplary embodiment, I/O interface 208 may be configured to receive and transmit data associated with (input/output) I/O devices and computer system 200. In an exemplary embodiment, I/O devices may comprise one or more peripheral devices. In an exemplary embodiment, processing unit 202 may communicate with I/O devices through I/O interface 208. In an exemplary embodiment, input device unit 214 and output device unit 216 may be connected to the computer system 200 through I/O interface 208. In an exemplary embodiment, input device unit 214 may comprise a keyboard, a mouse, a scanner, a microphone, a light pen, or other types of input devices that are well known for those skilled in the art. In an exemplary embodiment, output device unit 216 may comprise a printer, a headphone, a speaker, or other types of output devices that are well known for those skilled in the art. In an exemplary embodiment, I/O interface 208 may be connected to communication infrastructure 212.

In an exemplary embodiment, a computer program may be stored in storage unit 204. In an exemplary embodiment a computer program, when executed, enables computer system 200 to implement different embodiments of the present disclosure as discussed in further detail below. In particular, the computer program, when executed, enables processing unit 202 to implement the processes of the present disclosure, such as the operations in method 100 illustrated by flowchart 100 of FIG. 1 discussed above.

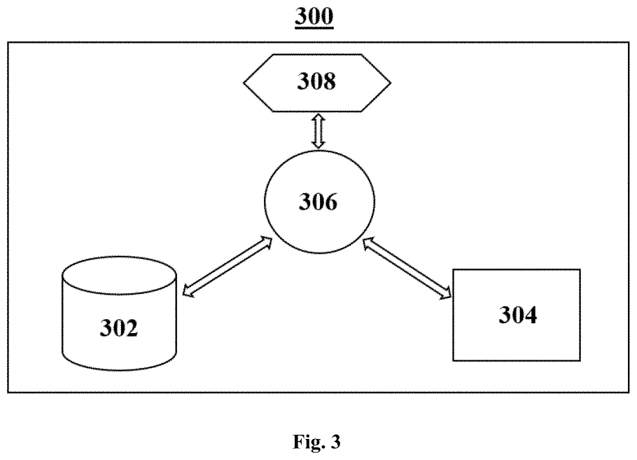

FIG. 3 illustrates an exemplary block diagram of an exemplary computer program that executes on the computer system 200, consistent with one or more exemplary embodiments of the present disclosure. In an exemplary embodiment, an exemplary computer program, hereinafter also referred to as a plant design application 300, as illustrated in FIG. 3, may comprise an application database 302, an application engine 304, an application core 306, and a GUI unit 308.

In an exemplary embodiment, the application database 302 may comprise a pre-defined database and a user-defined database. In an exemplary embodiment, the pre-defined database may include a P&ID database, a civil database, an equipment database, an electrical database, a piping database, and an HVAC database. In an exemplary embodiment, the user-defined database may be configured to store custom data associated with a plant design process by a user. In an exemplary embodiment, application engine 304 may comprise an artificial intelligence (AI) engine that may be configured to perform a plant design process utilizing processing unit 202. In an exemplary embodiment, the AI engine may be configured to perform a high-precision plant design with a design accuracy in the range of 10∧(−10) to 10∧(−20) utilizing the processing unit 202. In an exemplary embodiment, the application core 306 may be configured to establish a connection between the GUI unit 308, the application engine 304, the application database 302, and the computer system 200. In an exemplary embodiment, the GUI unit 308 may comprise a plurality of graphical user interface (GUI) modules. In an exemplary embodiment, GUI modules may be responsive to user inputs and may enable a user to perform an operation in accordance with the user inputs. In an exemplary embodiment, first GUI module, hereinafter also referred to as a plant admin module, may be configured to manage one or more users and monitor users' performance. In an exemplary embodiment, second GUI module, hereinafter also referred to as a plant data module, may be configured to create a library associated with a user's role. In an exemplary embodiment, third module, hereinafter also referred to as a P&ID module, may be configured to enable a user to design a process flow diagram (PFD) and a piping & instrumentation diagram (P&ID). In an exemplary embodiment, forth GUI module, hereinafter also referred to as a civil module, may be configured to enable a user to design plant civil structures. In an exemplary embodiment, fifth GUI module, hereinafter also referred to as an equipment module, may be configured to enable a user to design a plurality of plant equipment. In an exemplary embodiment, sixth GUI module, hereinafter also referred to as a piping module, may be configured to enable a user to design plant piping structures. In an exemplary embodiment, seventh GUI module, hereinafter also referred to as an electrical module, may be configured to enable a user to design plant electrical models. In an exemplary embodiment, eighth GUI module, hereinafter also referred to as an HVAC module, may be configured to enable a user to design plant heating, ventilation, and air conditioning (HVAC) models. In an exemplary embodiment, ninth GUI module, hereinafter also referred to as a viewer module, may be configured to enable a user to create an integrated 3-dimensional (3D) model of a plant design. In an exemplary embodiment, the plant design application 300 may comprise an automated design mode, a semi-automated design mode, and a manual design for each of the GUI modules. In an exemplary embodiment, automated design mode may be configured to enable the users to perform an operation associated with a plant design process automatically utilizing the application engine 304. In an exemplary embodiment, semi-automated design mode may be configured to enable users to perform an operation associated with a plant design process by combined activities of users and the application engine 304. In an exemplary embodiment, manual design mode may be configured to enable users to perform an operation associated with a plant design process in a total manual way by activities of users. In an exemplary embodiment, further detail of each of the above-mentioned GUI modules is described below.

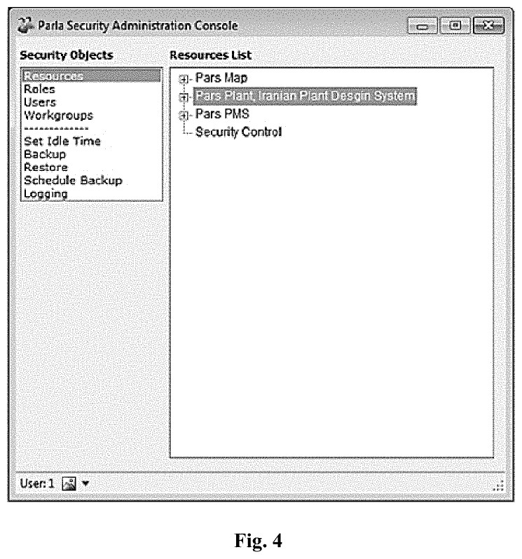

For further detail with regards to method 100 and plant design application 300, FIG. 4 shows an example of plant admin module 400, consistent with one or more exemplary embodiments of the present disclosure.

In an exemplary embodiment, plant admin module 400 may be configured to manage a plurality of users and analyze users' performance. In an exemplary embodiment, users may include one or more ordinary users and an administrator. In an exemplary embodiment, a user may be defined as an administrator, and an administrator's username and an administrator's password may be associated with an administrator's account. In an exemplary embodiment, the administrator may manage each of the ordinary users utilizing the plant admin module. For example, the administrator may create or modify a user's account, assign or modify a user's role, assign or modify user's resources, and analyze a user's performance. In an exemplary embodiment, user rolls may comprise a P&ID user, a civil user, a piping user, an electrical user, an equipment user, and an HVAC user. For example, user's resources may include a plurality of connections, a plurality of profiles, a plurality of materials, a plurality of component catalogs. In an exemplary embodiment, the administrator may define a plurality of projects and assign one or more users to each of the plurality of projects.

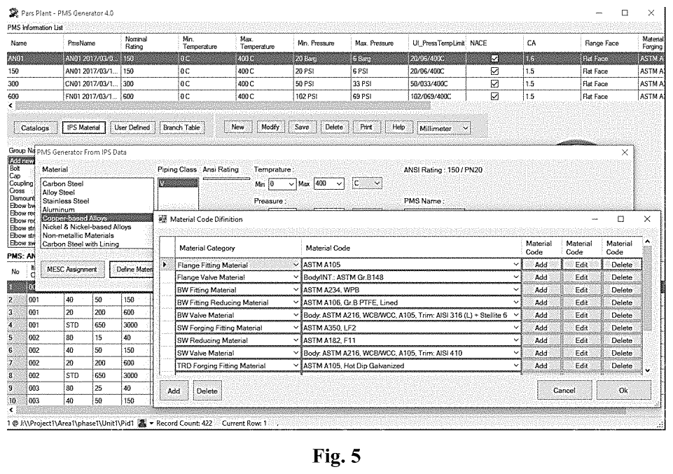

For further detail with regards to method 100 and plant design application 300, FIG. 5 shows an example of data module 500, consistent with one or more exemplary embodiments of the present disclosure.

In an exemplary embodiment, the data module 500 may comprise a (piping material specification) PMS and catalog generator unit. In an exemplary embodiment, a user may be enabled to generate a plurality of component catalogs, branch tables, and PMS utilizing the data module 500 automatically. For example, each of the component catalogs may include one or more schematic pictures, a plurality of component dimensions, a component material. In an exemplary embodiment, component catalogs may be designed as templates in the data module 500.

In an exemplary embodiment, PMS may comprise a plurality of piping components. In an exemplary embodiment, piping components may comprise a plurality of valves, pipes, connections, tees, elbows, flanges, or other piping components that are well known for those skilled in the art. In an exemplary embodiment, data module 500 may comprise an automatic and manual operation mode. In an exemplary embodiment, manual operation mode may be configured to enable a user to create each of the plurality of component catalogs, branch tables, and PMS manually. In an exemplary embodiment, data module 500 may create PMS based on a plurality of PMS standards. In an exemplary embodiment, PMS standards may comprise ANSI, ASTM, DIN, ASME, IPS, IGS, or other PMS standards that are well known for those skilled in the art. In an exemplary embodiment, the data module 500 may include a pre-defined database and a user-defined database. In an exemplary embodiment, the pre-defined database may include a P&ID database, a civil database, an equipment database, an electrical database, a piping database, and an HVAC database. In an exemplary embodiment, the user-defined database may be configured to store custom data associated with a plant design process by a user. In an exemplary embodiment, the PMS and catalog generator unit may create a PMS table based on a plurality of user's options. For example, the user's options may include a type of material, a piping class, an ANSI rating, a temperature, and a pressure.

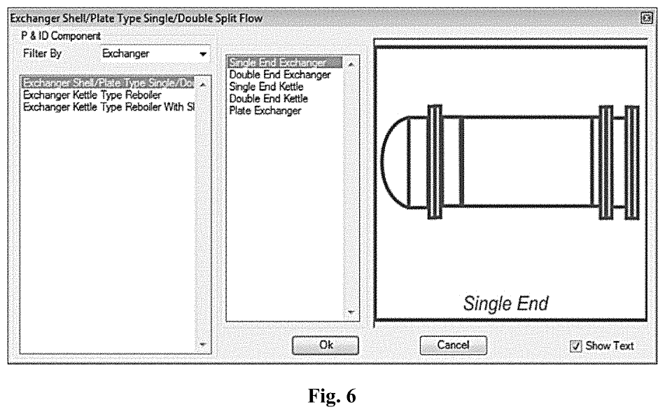

For further detail with regards to method 100 and plant design application 300, FIG. 6 shows an example of P&ID module 600, consistent with one or more exemplary embodiments of the present disclosure.

In an exemplary embodiment, a user may perform a P&ID and PFD design based on the P&ID database utilizing the P&ID module 600. In an exemplary embodiment, the P&ID database may comprise a line database and a template database. In an exemplary embodiment, line database may comprise a plurality of fluid lines, electrical lines, equipment lines, supply lines, sonic lines, pneumatic lines, or other types of lines that may be used in P&ID drawings. In an exemplary embodiment, the template database may comprise a plurality of P&ID components. In an exemplary embodiment, P&ID components may be designed as user-friendly and dynamic templates. In an exemplary embodiment, the P&ID module 600 may include a P&ID setup unit. In an exemplary embodiment, the P&ID user may define one or more primary settings and a layout design feature in the P&ID setup unit. For example, primary settings may include defining one or more component dimensions and line numbers. In an exemplary embodiment, layout design feature may include a single sheet layout design or a multi-sheet layout design. In an exemplary embodiment, P&ID components may include a plurality of exchangers, pumps, tanks, towers, vessels, valves, instruments, miscellaneous, joints, connections, insulations, wells, or other types of P&ID components that may be used in P&ID drawings. In an exemplary embodiment, the exchangers may include a kettle type reboiler exchanger, a kettle type reboiler with skirt exchanger, a shell/plate type single/double split-flow exchanger, or other types of exchanges that may be used in P&ID drawings. In an exemplary embodiment, vessels may include a horizontal vessel, horizontal vessel with boot and skirt, a hortonshere vessel, horizontal with boot vessel, horizontal with skirt vessel, vertical vessel, vertical flat head and skirt vessel, vertical flat head vessel, a vertical with skirt vessel, or other types of vessels that may be used in P&ID drawings. In an exemplary embodiment, valves may include butt-weld valves, butt-weld control valves, flange valves, flange control valves, well-head valves, socket-weld valves, socket-weld control valve, thread valves, thread control valves, or other types of valves that may be used in P&ID drawings. In an exemplary embodiment, instruments may include fitting instruments, computer instruments, discrete instruments, logic instruments, pilot instruments, shared instruments, or other types of instruments that may be used in P&ID drawings. In an exemplary embodiment, pumps may include jacky pumps, centrifuge pumps, in-line pumps, multi-stage pumps, split-case pumps, sump pumps, turbine pumps, well-head pumps, or types of pumps that may be used in P&ID drawings. In an exemplary embodiment, wells may include head-pump wells, head-valve wells, or other types of wells that may be used in P&ID drawings. In an exemplary embodiment, the P&ID user may design and modify each of the plurality of P&ID components utilizing user-friendly and dynamic templates. For example, the P&ID user may change or define one or more P&ID component dimensions utilizing templates. For example, P&ID component dimensions may include one or more component lengths, widths, and heights.

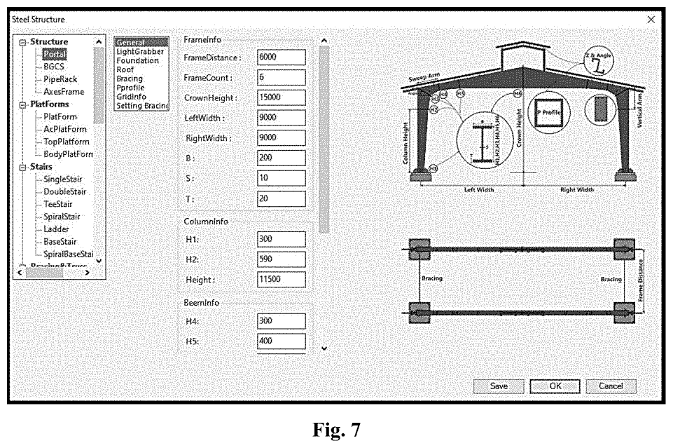

For further detail with regards to method 100 and plant design application 300, FIG. 7 shows an example of civil module 700, consistent with one or more exemplary embodiments of the present disclosure.

In an exemplary embodiment, the civil module 700 may be configured to design plant civil structures utilizing the civil database. In an exemplary embodiment, civil database may comprise a plurality of civil components. For example, civil components may comprise a plurality of axes frames, portals, platforms, booster gas control systems, pipe racks, stairs, ladders, trusses, guards, foundations, connections, columns, reducers, trench sections, pavements, knees, rails, or other types of civil components that may be used in plant civil structures. In an exemplary embodiment, stairs may comprise single stairs, double stairs, tee stairs, spiral stairs, or other types of stairs that may be used in plant civil structures. In an exemplary embodiment, connections may comprise web connections, flange connections, beam connections, column connections, concrete connections, welded connections, bolted connections, combined connections, or other types of connections that may be used in plant civil structures.

In an exemplary embodiment, civil components may be designed as user-friendly and dynamic templates. In an exemplary embodiment, the civil user may design and modify civil components utilizing templates based on a set of civil design options that may be determined by the civil user in the templates. For example, civil design options may comprise one or more component dimensions, component material, horizontal profile, vertical profile, and component overlaps.

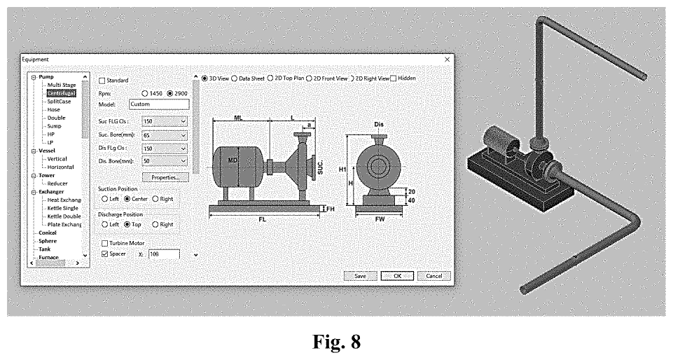

For further detail with regards to method 100 and plant design application 300, FIG. 8 shows an example of equipment module 800, consistent with one or more exemplary embodiments of the present disclosure.

In an exemplary embodiment, equipment module 800 may be configured to design a plant equipment model utilizing the equipment database. In an exemplary embodiment, equipment database may comprise a plurality of plant equipment. plant equipment may refer to common equipment that may be used in a plant structure, for example, tanks.

In an exemplary embodiment, plant equipment may comprise a plurality of vessels, towers, tanks, furnaces, scrapers, air coolers, compressors, blowers, pumps, boilers, chillers, kettles, exchangers, and other plant equipment that may be used in a plant structure. In an exemplary embodiment, vessels may comprise horizontal vessels, vertical vessels, sphere vessels, conical vessels, or other types of vessels that may be used in a plant structure. In an exemplary embodiment, pumps may comprise centrifuge pumps, multi-stage pumps, split-case pumps, sump pumps, HP in-line pumps, LP in-line pumps, double pumps, hose pumps, or other types of pumps that may be used in a plant structure. In an exemplary embodiment, boilers may comprise hot water boilers, steam boilers, or other types of boilers that may be used in a plant structure. In an exemplary embodiment, chillers may comprise absorption chillers, centrifugal chillers, direct-field chillers, reciprocating chillers, double-effect chillers, or other types of chillers that may be used in a plant structure.

In an exemplary embodiment, plant equipment may be designed as user-friendly and dynamic templates. In an exemplary embodiment, the equipment user may design and modify plant equipment utilizing templates based on a set of equipment design options that may be determined by the equipment user in the templates. For example, equipment design options may comprise one or more component dimensions, component material, suction position, vertical profile, revolutions per minute (RPM), and component model.

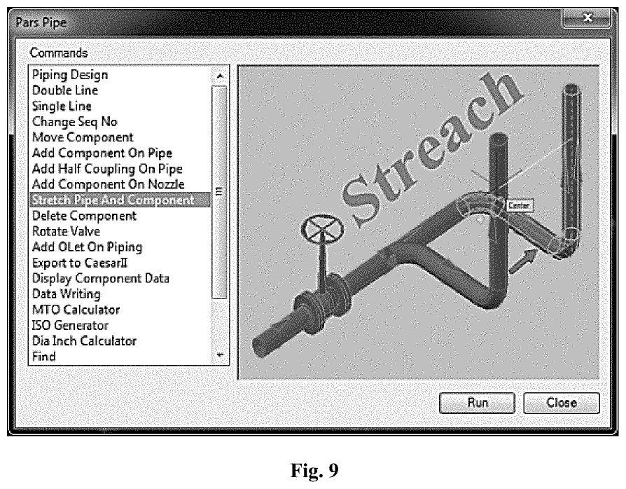

For further detail with regards to method 100 and plant design application 300, FIG. 9 shows an example of piping module 900, consistent with one or more exemplary embodiments of the present disclosure.

In an exemplary embodiment, piping module 900 may be configured to design a plant piping model utilizing the piping database. In an exemplary embodiment, piping database may comprise a plurality of piping components and PMSs.

In an exemplary embodiment, the piping module 900 may comprise a single-line design, a double-line design, and a 3-dimensional (3D) design mode. In an exemplary embodiment, the piping user may select a PMS, specify a piping size, and orient a pipe path, and then, the piping module 900 may perform piping calculations, piping resizing, piping branching, and piping orientation utilizing the application engine 304 automatically. In an exemplary embodiment, piping components may comprise a plurality of connections, pipes, valves, fittings, instruments, joints, filters, or other types of piping components that may be used in a plant piping structure. In an exemplary embodiment, connections may comprise butt-weld connections, socket-weld connections, thread connections, flange connections, PVC connections, sanitary connections, or other types of connections that may be used in a plant piping structure. In an exemplary embodiment, fittings may comprise flange fittings, elbow fittings, reducer fittings, tee fittings, tee-reducer fittings, crosse fittings, cross reducer fittings, or other types of fittings that may be used in a plant piping structure.

In an exemplary embodiment, piping components may be designed as user-friendly and dynamic templates. In an exemplary embodiment, the piping user may design and modify piping components utilizing templates based on a set of piping design options that may be determined by the piping user in the templates. For example, piping design options may comprise one or more component dimensions, component position, component's end type, component's flange type, component's elbow type, and connection type of component.

In an exemplary embodiment, piping module 900 may further comprise an auto-clash unit. In an exemplary embodiment, auto-clash unit may be configured to detect piping collisions during a piping design utilizing the application engine 304 and warn the piping user to modify the piping design.

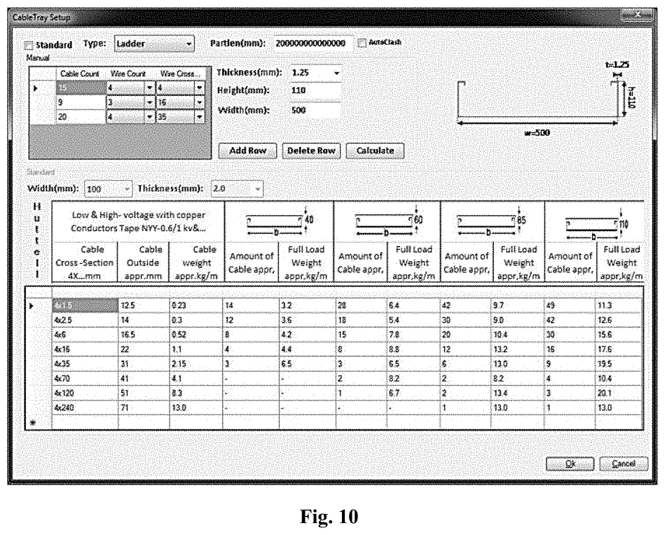

For further detail with regards to method 100 and plant design application 300, FIG. 10 shows an example of electrical module 1000, consistent with one or more exemplary embodiments of the present disclosure.

In an exemplary embodiment, electrical module 1000 may be configured to design a plant electrical system utilizing the electrical database. In an exemplary embodiment, electrical database may comprise a plurality of electrical components. In an exemplary embodiment, electrical components may refer to components that may be used in a building electrical system, for example, cables and cable trays. For example, electrical module 1000 may enable the electrical user to perform cable trays design, arrange cables, and 3D modeling of cable trays associated with engineering standards. In an exemplary embodiment, electrical components may comprise a plurality of cable trays, cables, routes, or other types of electrical components that may be used in plant electrical systems. In an exemplary embodiment, cable trays may comprise standard trays, rack trays, ladder trays, bus duct arc trays, bus duct rectangle trays, or other types of cable trays that may be used in plant electrical systems.

In an exemplary embodiment, electrical components may be designed as user-friendly and dynamic templates. In an exemplary embodiment, the electrical user may design and modify electrical components utilizing templates based on a set of electrical design options that may be determined by the electrical user in the templates. For example, electrical design options may comprise one or more component dimensions, component position, and component type.

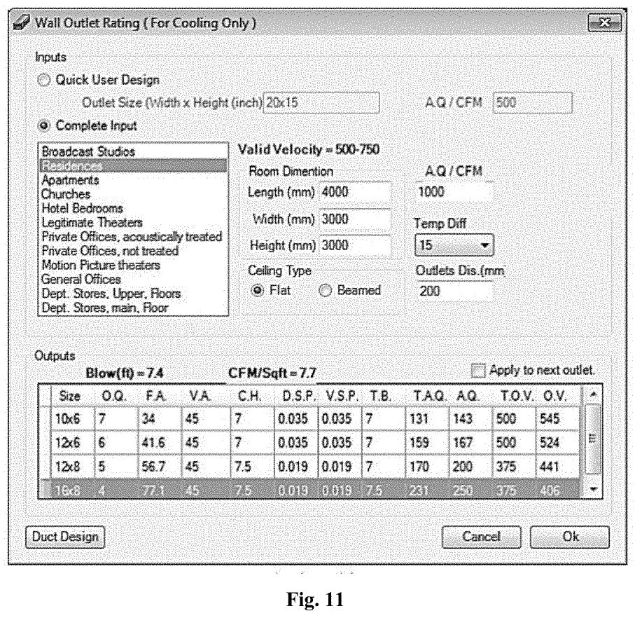

For further detail with regards to method 100 and plant design application 300, FIG. 11 shows an example of HVAC module 1100, consistent with one or more exemplary embodiments of the present disclosure.

In an exemplary embodiment, HVAC module 1100 may be configured to design a plant HVAC system utilizing the HVAC database. In an exemplary embodiment, HVAC database may comprise a plurality of HVAC components. For example, HVAC module 1000 may enable the HVAC user to design and generate 3D air duct models associated with air HVAC design standards. In an exemplary embodiment, HVAC components may comprise a plurality of elbows, tees, crosses, reducers, connections, diffusers, supports, flanges, or other HVAC components that may be used in plant HVAC systems.

In an exemplary embodiment, HVAC module 1100 may be configured to calculate HVAC air-ducts dimensions and calculate a fluid flowrate automatically and perform smart ducting design utilizing application engine 304. In an exemplary embodiment, HVAC components may be designed as user-friendly and dynamic templates. In an exemplary embodiment, the HVAC user may design and modify HVAC components utilizing templates based on a set of HVAC design options that may be determined by the HVAC user in the templates. For example, HVAC design options may comprise one or more component dimensions, component position, fluid velocity, component angles, component type, component radius factor, component slope factor, friction loss, and air quantity.

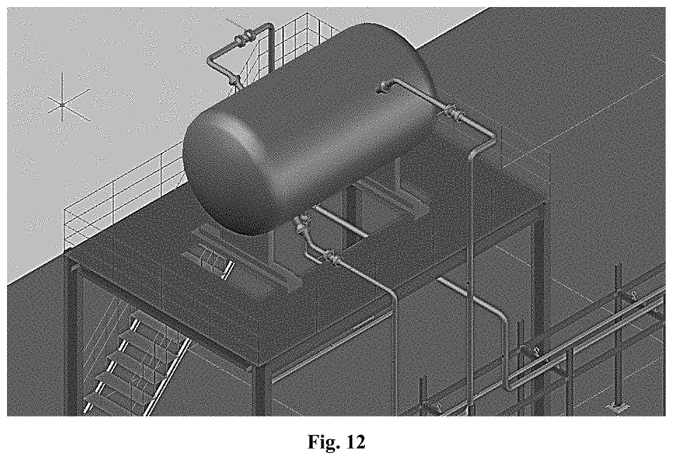

For further detail with regards to method 100 and plant design application 300, FIG. 12 shows an example of viewer module 1200, consistent with one or more exemplary embodiments of the present disclosure.

In an exemplary embodiment, the viewer module 1200 may be configured to generate a walk-through 3D interactive environment model of a plurality of plant designs. In an exemplary embodiment, a user may select each of P&ID, PFD, plant civil structures, plant equipment models, plant piping models, plant electrical systems, and plant HVAC systems, and then the viewer module 1200 may create an integrated walk-through 3D plant model. In an exemplary embodiment, a user may walk in the interactive environment model through a human symbol that may be embedded in the viewer module 1200. For example, a user may control human symbol movements utilizing a mouse and a keyboard that may be connected to the computer system 200.

Furthermore, it is to be understood that the invention is solely defined by the appended claims. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “at least one” and indefinite articles such as “a” or “an” (e.g., “a” and/or “an” should typically be interpreted to mean “at least one” or “one or more” or “a plurality of”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood that the terms and expressions used herein have the ordinary meaning as is accorded to such terms and expressions with respect to their corresponding respective areas of inquiry and study except where specific meanings have otherwise been set forth herein. Relational terms such as first, second, and third and the like may be used solely to distinguish one entity or action from another without necessarily requiring or implying any actual such relationship or order between such entities or actions. The terms “comprises,” “include,” “comprising,” or any other variation thereof, are intended to cover a non-exclusive inclusion, such that a process, method, article, apparatus, or device that comprises a list of elements does not include only those elements but may include other elements not expressly listed or inherent to such process, method, article, apparatus, or device. An element proceeded by “a” or “an” does not, without further constraints, preclude the existence of additional identical elements in the process, method, article, or device that comprises the element. Moreover, “may” and other permissive terms are used herein for describing optional features of various embodiments. These terms likewise describe selectable or configurable features generally, unless the context dictates.]

What is claimed is:

1. A method for integrated plant designing, the method comprising:
providing a plant library based on one or more user's selections utilizing a computing device, the plant library comprising a pre-defined database, a user-defined database, or the pre-defined and user-defined databases;
designing a process flow diagram (PFD) and a piping & instrumentation diagram (P&ID) by a user based on a plurality of P&ID components, wherein the user selects each of the plurality of P&ID components and modifies and manages each of the plurality of P&ID components associated with the P&ID and PFD;
designing a plant civil structure model by the user based on a plurality of civil components, wherein the plant civil structure is associated with a plurality of steel and concrete structures and the user selects one or more civil components and modifies and manages each of the plurality of civil components associated with the plant civil structure to perform designing and modeling one or more steel and concrete structures;
designing a plant equipment model by the user based on a plurality of plant equipment, wherein the user selects each of the plurality of plant's equipment and modifies and designs each of the plurality of plant's equipment in two dimensions and three dimensions models;
designing a plant piping structure model by the user based on a plurality of piping material specifications (PMS), wherein the user selects each of the plurality of piping material specifications and performs designing and modeling of the plant piping structure;
designing a plant electrical model by the user based on a plurality of electrical components, wherein a user selects each of the plurality of electrical components and modifies and designs each of the plurality of electrical components;
designing a plant heating, ventilation, and air conditioning (HVAC) model by the user based on a plurality of HVAC components, wherein a user selects each of the plurality of HVAC components and modifies and designs the plant HVAC model;
wherein designing the PFD and P&ID, the plant civil structure model, the plant equipment model, the plant piping structure model, the plant electrical model, and the plant HVAC model are provided through the plant library utilizing the computing device; and
combining each of the PFD and P&ID, the plant civil structure model, the plant piping structure model, the plant electrical model, and the plant HVAC model by the user and generating an integrated 3-dimensional (3D) model of a plant design utilizing the computing device.

2. The method according to claim 1, the user generates an optimized design utilizing the computing device through a set of user's input specifications and the plant library.

3. The method according to claim 1, wherein the computing device comprises a processing unit, a storage unit, a display unit, and an input/output (I/O) unit.

4. The method according to claim 1, wherein the pre-defined database comprises one or more P&ID components, one or more civil components, one or more plant equipment, one or more piping material specifications, one or more electrical components, one or more, and HVAC components.

5. A system that enables users to perform an integrated plant design utilizing artificial intelligence (AI), the system comprising:
(a) a computing device comprising:
a display unit;
a storage unit having processor-readable instructions and an application stored therein;
a processing unit comprising one or more processors, wherein the processing unit is configured to access the storage unit and execute the processor-readable instructions and the application which, when executed by the one or more processors configures the one or more processors to perform a method that is associated with the application; and
an input/output (I/O) unit, the I/O unit comprises a plurality of peripheral devices;
(b) the application executing on the computing device comprising one or more graphical user interface modules, an application core, an application engine, and an application database, wherein an integrated plant design process utilizing the application is as follows:
(i) defining one or more users utilizing an admin module, the users comprising an admin user and one or more ordinary users, wherein the admin user assign ordinary users' roles and manage the ordinary users;
(ii) providing a plant library based on the ordinary users' roles utilizing a data module, the plant library comprising a pre-defined database, a user-defined database, or the pre-defined and user-defined databases;
(iii) designing a process flow diagram (PFD) and a piping & instrumentation diagram (P&ID) by a P&ID user based on a plurality of P&ID components utilizing a P&ID module, wherein the P&ID user selects each of the plurality of P&ID components and modifies and manages each of the plurality of P&ID components associated with the P&ID and PFD;
(iv) designing a plant civil structure model by a civil user based on a plurality of civil components utilizing a civil module, wherein the plant civil structure is associated with a plurality of steel and concrete structures and the civil user selects one or more civil components and modifies and manages each of the plurality of civil components associated with the plant civil structure to perform designing and modeling one or more steel and concrete structures;
(v) designing a plant equipment model by an equipment user based on a plurality of plant equipment utilizing an equipment module, wherein the equipment user selects each of the plurality of plant's equipment and modifies and designs each of the plurality of plant's equipment in two dimensions and three dimensions models;
(vi) designing a plant piping structure model by a piping user based on a plurality of piping components utilizing a piping module, wherein the piping user selects each of the plurality of piping components and performs designing and modeling of the plant piping structure;
(vii) designing a plant electrical model by an electrical user based on a plurality of electrical components utilizing an electrical module, wherein the electrical user selects each of the plurality of electrical components and modifies and designs each of the plurality of electrical components;
(viii) designing a plant heating, ventilation, and air conditioning (HVAC) model by an HVAC user based on a plurality of HVAC components utilizing an HVAC module, wherein the HVAC user selects each of the plurality of HVAC components and modifies and designs the plant HVAC model;
(ix) wherein designing the PFD and P&ID, the plant civil structure model, the plant equipment model, the plant piping structure model, the plant electrical model, and the plant HVAC model are provided through the plant library and artificial intelligence algorithms; and
(x) combining each of the PFD and P&ID, the plant civil structure model, the plant piping structure model, the plant electrical model, and the plant HVAC model and generating an integrated 3-dimensional (3D) model of a plant design utilizing the application engine.

6. The system according to claim 5, wherein the application engine comprises an AI engine, AI engine is configured to perform an automatic and optimized design through the application database and a set of users' input specifications.

7. The system according to claim 5, wherein the application core is configured to establish a connection between the GUI modules, the application engine, the application database, and the computing device.

8. The system according to claim 5, wherein the application database comprises a pre-defined database and a user-defined database.

9. The system according to claim 8, wherein the pre-defined database comprises a P&ID database, a civil database, an equipment database, an electrical database, a piping database, and an HVAC database.

10. The system according to claim 8, wherein the P&ID components, the civil components, the plant equipment, the piping components, the electrical components, and the HVAC components are provided as dynamic templates in the application.

11. The system according to claim 10, wherein dynamic templates comprise one or more component figures and a set of component specifications.

12. The system according to claim 11, wherein the set of component specifications comprises one or more numerical constraints and/or constants, one or more component dimensions, type of component, component material, and a plurality of design variables that are determined by the users.

13. The system according to claim 5, wherein the storage unit comprises one or more memories associated with the application and the processing unit.

14. The system according to claim 5, wherein the application comprises an automated design mode, a semi-automated design mode, and a manual design for each of the GUI modules.
